(19) United States
(12) Patent Application Publication
(10) Pub. No.: US 2012/0073600 A1
(43) Pub. Date: Mar. 29, 2012

(54) METHOD AND DEVICE FOR TREATING SURFACES

(76) Inventor: Leif Yxfeldt, Stockholm (SE)

(21) Appl. No.: 13/375,905

(22) PCT Filed: Jun. 3, 2010
(86) PCT No.: PCT/SE10/50608

§ 371 Date: Dec. 2, 2011

(30) Foreign Application Priority Data
Jun. 3, 2009 (SE) 0950402-8

(51) Int. Cl. B08B 3/04; A47L 9/04; A47L 11/00; B08B 5/04

(52) U.S. Cl. 134/6; 15/320; 15/322

(57) ABSTRACT

A method and an arrangement for cleaning a soiled surface in which cleaning liquid is applied thereto, a mouthpiece provided with a cover is passed over the surface that has had the cleaning liquid applied thereto, at the same time as a brush mounted inside the cover and having a principally cylindrical form with its axis principally parallel to the coated surface, and having such a diameter that it protrudes outside of the mouthpiece in a direction towards the surface to be cleaned, is caused to rotate at approximately 2,000 rpm or higher in order to support the mouthpiece and treat the surface to break up the cleaning liquid and dirt that has been dissolved by the cleaning liquid and the brush into small particles that are withdrawn by suction from the cover and from the surface with an evacuation pipe that is connected to the cover by a connector.

The present invention concerns a method and an arrangement for the treatment with liquid of surfaces, in particular for the cleaning of soiled surfaces, in particular for the removal of graffiti, and in particular for the removal of the graffiti known as “tags”.

During the treatment, such as cleaning, with liquid of horizontal surfaces, the liquid is generally dried off with a rag, removed by suction, scraped off, or allowed, quite simply, to air dry. During the treatment with liquid of tilted surfaces, the liquid tends to run down from the treated surface until it reaches a support, if it does not have a high density.

This is a serious problem in itself if the liquid is corrosive or harmful to the environment, or both, and it severely limits the possibilities of cleaning heavily soiled surfaces with the liquid in question. Furthermore, when cleaning tilted surfaces, any rinse water runs down to the next level, and the problem arises for horizontal surfaces of how to get rid of the rinse water.

Special cleaning liquid is applied for the removal of graffiti, which cleaning liquid has been adapted to the solvent in the graffiti that is to be removed. After the agent in the cleaning liquid has been allowed to act for a period, it is washed or wiped away with the aid of high-pressure rinsing or wiping with a rag. Neither of these methods is particularly suitable if the cleaning liquid contains powerful solvents that should be sent to be destroyed.

A cleaning mouthpiece that comprises a brush that rotates in a circular manner over the surface that is to be cleaned is previously known. The liquid that is used to dissolve the dirt present on the surface is applied to the surface through a supply line, in order subsequently to be worked with the aid of the mouthpiece. The mouthpiece is furthermore connected with the aid of an evacuation pipe to a vacuum extraction container, to which it is intended that the dissolved dirt and the remaining cleaning agent be withdrawn in order that it should be possible to reuse the cleaning liquid and return it again to the mouthpiece. The arrangement has a sealing strip that passes around the mouthpiece and negative pressure is established within the sealing strip of the mouthpiece with the aid of the evacuation pipe, which negative pressure is intended to prevent the applied cleaning liquid from escaping from the mouthpiece. One disadvantage of this known method and this known arrangement is that the arrangement is very heavy to handle, and another disadvantage is that the rotating brush has a tendency to spread the dissolved dirt in an even layer across the whole of the treated surface. If, for example, the dirt consists of a dark paint that has been applied to a light wall, the wall will through the treatment often obtain a certain discolouration across the entire surface, instead of being cleaned at the location at which the paint has been applied. Furthermore, since the cleaning liquid is reused, there is a risk that also other non-painted surfaces will become discoloured by the cleaning liquid, and that the discolouration will tend to become fixed even more firmly to the supporting surface.

It is therefore one purpose of the invention to achieve a solution to the problems described above through a new method and a new arrangement, such that the cleaning liquid with the dissolved dirt can be efficiently removed from the surface that is being cleaned, and that this should take place under conditions that are sensitive to the environment.

The purpose described above is achieved according to the invention with a method in which cleaning liquid is applied to the surface that is to be cleaned and that, according to the invention, a mouthpiece provided with a mouthpiece cover is passed over the surface that has had the cleaning liquid applied to it, at the same time as a brush mounted inside the mouthpiece cover and having a principally cylindrical form with its axis principally parallel to the coated surface, and having such a diameter that it protrudes somewhat outside of the mouthpiece in a direction towards the surface that is to be cleaned, is caused to rotate with a rate of revolution of approximately 2,000 rpm or higher in order to support the mouthpiece and treat the surface with the applied cleaning liquid and to break up the cleaning liquid and the dirt that has been dissolved by the cleaning liquid and the brush into small particles that are withdrawn by suction from the mouthpiece cover and from the surface with the aid of an evacuation pipe that is connected to the mouthpiece cover by a connector.

The purpose of achieving an arrangement for the treatment with liquid of surfaces is solved with a mouthpiece that is equipped with a mouthpiece cover designed principally such that it makes contact with the surface that is to be cleaned, whereby the mouthpiece cover of the mouthpiece comprises a connector for an evacuation pipe and where the mouthpiece furthermore is equipped with a rotating brush with a cylindrical form, which brush rotates at a rate of revolution of approximately 2,000 rpm or higher and has such a diameter that it protrudes somewhat outside of the mouthpiece in a direction towards the surface that is to be cleaned such that it rotates around an axis that is parallel to the surface that is to be cleaned in order to support the mouthpiece and treat the surface with the applied cleaning liquid and break up the cleaning liquid and the dirt that has been dissolved by the cleaning liquid to small liquid particles, which particles can be withdrawn by suction through the evacuation pipe.

According to one preferred embodiment of the arrangement according to the invention, the evacuation pipe that is connected to the mouthpiece is connected at its second end to a container in which the dissolved dirt and the cleaning liquid are collected.

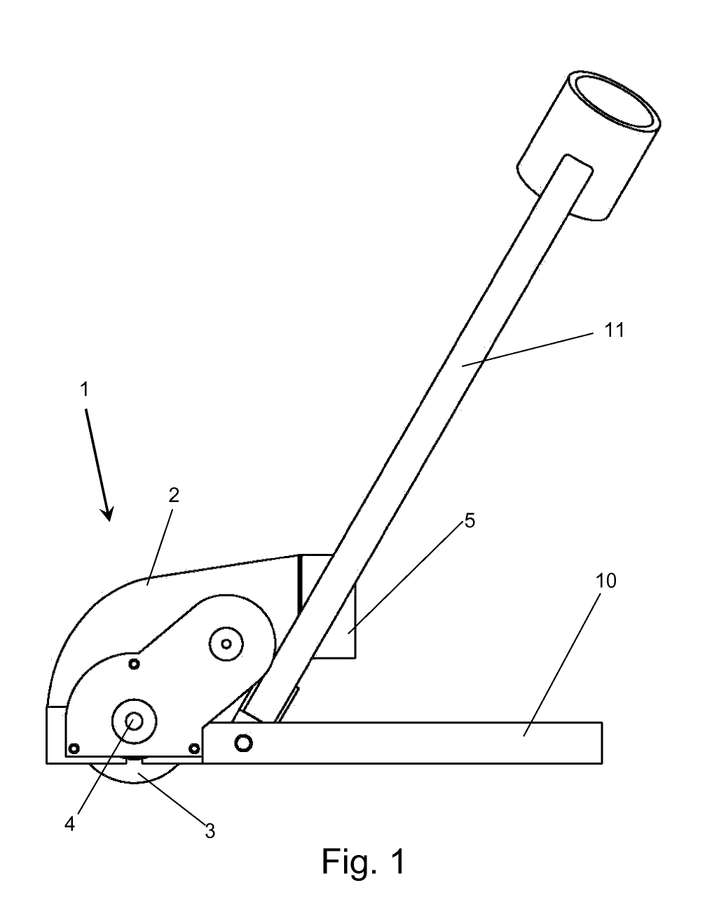

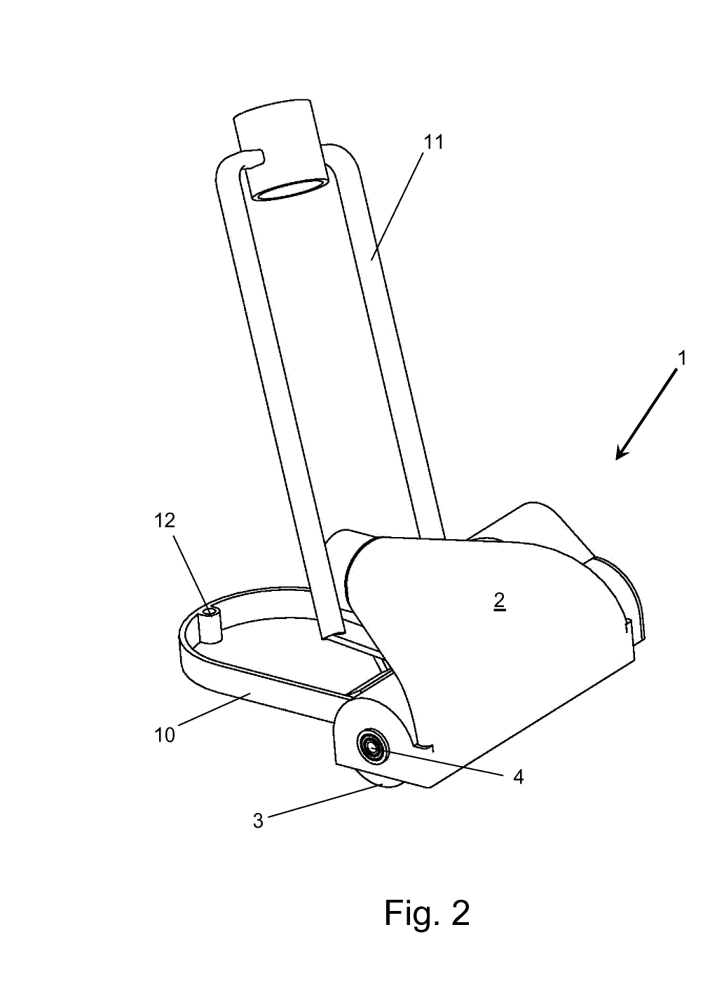

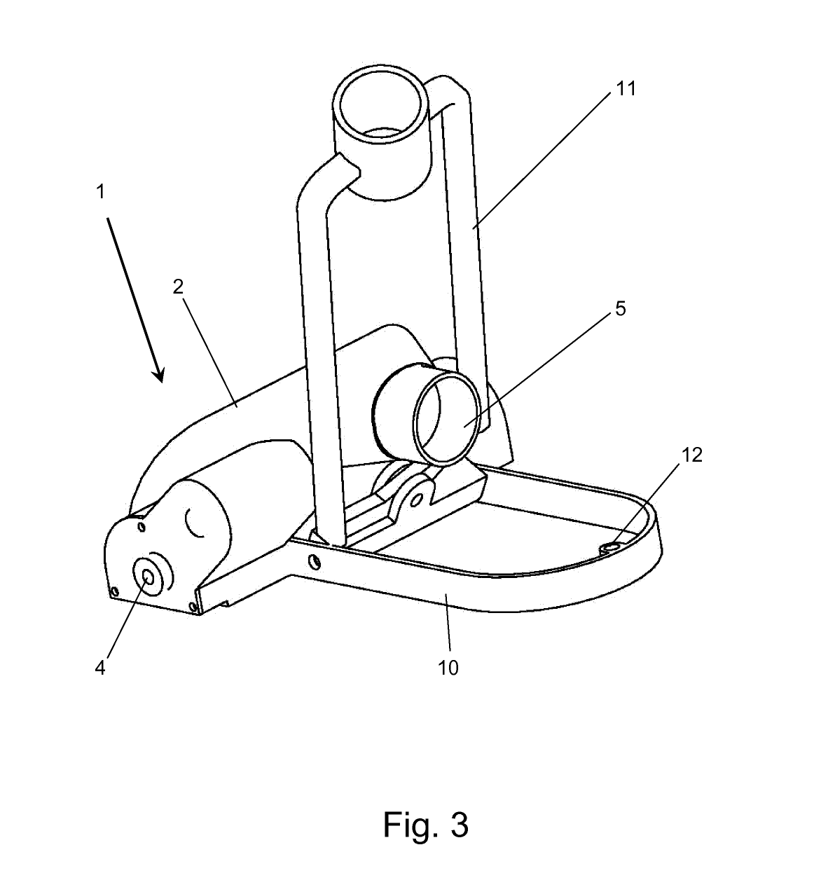

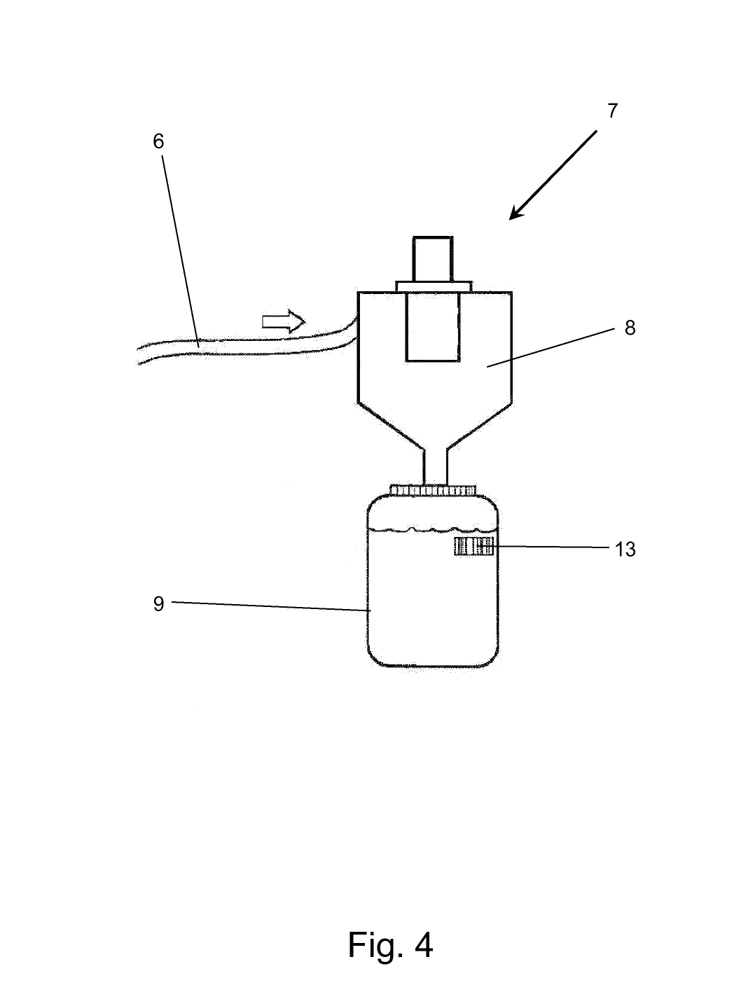

The invention will now be described in more detail in the form of a non-limiting embodiment, illustrated with the aid of the attached drawings, where FIG. 1 shows a schematic side view of a mouthpiece for the cleaning of a surface, FIG. 2 shows a schematic perspective view of the mouthpiece in FIG. 1 obliquely from the front. FIG. 3 shows a corresponding perspective view obliquely from the rear, and FIG. 4 shows a schematic view of an evacuation pipe and container according to the preferred embodiment of the invention.

Thus, a mouthpiece for the cleaning of a surface that is to be cleaned from dirt, for example, to be cleaned from graffiti is shown in the drawings. The surface is assumed to be horizontal in the views shown, but it is probably more common in practice that the surface is vertical, or at least tilted. A cleaning liquid for dissolving dirt is applied to the surface that is to be cleaned, and when the cleaning liquid has been allowed to act and dissolve the dirt for a certain period the arrangement according to the invention is activated. The arrangement comprises a mouthpiece 1 that is arranged to lie against the surface that is to be, cleaned, at a short distance from the surface.

The mouthpiece 1 has a mouthpiece cover 2 that is open towards the surface that is to be cleaned and it has an edge that is located at a short distance from the surface that is to be cleaned when the mouthpiece is being used. A brush 3 is arranged inside the mouthpiece cover 2, which brush is principally cylindrical and is arranged with its axle lying parallel to the surface that is to be cleaned. The distance of the axle 4 from the surface that is to be cleaned is somewhat less than the radius of the brush 3, such that the bristles of the brush 3 protrude from under the lower surface of the mouthpiece and are brought into contact with the surface that is to be cleaned without the mouthpiece cover coming into contact with the surface that is to be cleaned.

The brush 3 is driven by a suitable method, for example by an electric motor and a rechargeable battery. The brush may, however, be driven by other methods, for example by pressurised air.

Furthermore, an evacuation pipe 6 is connected to the mouthpiece cover of the mouthpiece through a connector 5, shown only in FIG. 4, with the aid of which dirt particles brushed up by the brush 3 can be transported to a liquid collection arrangement 7, shown in FIG. 4. It is appropriate that this liquid collection arrangement 7 comprise an air vacuum arrangement 8 in order to create negative pressure in the evacuation pipe, and a container 9 to collect the used cleaning liquid and the particles of dirt.

Application of the cleaning liquid onto the surface can take place by any suitable method, such as brushing onto the surface that is to be cleaned, or spraying, or application by roller onto the surface. It may be preferable that a feed line be arranged for this, in order to supply cleaning liquid from a container with the aid of a feed pump or from a pressurised container, for example a container that is pumped manually to the desired pressure, for application onto the surface that is to be cleaned, and where the feed line is connected at its second end to a roller, a brush or a sponge for the application of the cleaning liquid onto the surface.

After application of the cleaning liquid onto the surface that is to be cleaned, the brush 3 is activated in the mouthpiece such that it rotates rapidly, with a rate of revolution greater than 2,000 rpm, preferably approximately 3,000 rpm, such that cleaning liquid and the dissolved dirt are to be brushed up from the surface in such a manner that the particles of liquid containing cleaning liquid and dirt are broken up by the rapid rotation into very small particles, forming an aerosol, such that they can be readily extracted by suction through the evacuation pipe 6 to the liquid collection arrangement 7. It is appropriate that the air vacuum arrangement 8 be activated at the same time as the brush 3 is activated such that it rotates with the high rate of revolution for brushing up dirt and cleaning liquid from the surface. The mouthpiece cover 2 has an internal design such that it leads the brushed up liquid particles in an aerodynamic manner to the evacuation pipe 6 and out from the mouthpiece cover 2. The brush 3 is arranged to rotate in a direction such that dirt particles brushed up from the surface are sent directly towards the front end of the mouthpiece cover 2, and easily by the inner surface of the mouthpiece cover are directed towards the connector 5 of the evacuation pipe. Thus the brush 3 rotates clockwise as seen in FIG. 1. A flow of air within the mouthpiece cover is formed through the rapid rotation of the brush 3 and the negative pressure from the air vacuum arrangement 8 and the evacuation pipe 6, together with the fact that the mouthpiece cover 2 is located at a certain distance above the surface that is to be cleaned, such that essentially all cleaning liquid within the outer edges of the mouthpiece is extracted by suction through the evacuation pipe, as is also the dissolved dirt, leaving an essentially dry surface. A result of this is that the mouthpiece is suitable for use on both tilted and horizontal surfaces. The said flow of air contributes to the formation or aerosols by the particles of liquid and dirt with air, which is readily transported due to the internal aerodynamic design of the mouthpiece to the evacuation pipe 6 and onwards to the liquid collection arrangement 7. Also openings may be arranged in the mouthpiece cover 2 in order to allow air to enter the mouthpiece in order to facilitate the flow of air. The negative pressure is present in the mouthpiece cover, in principle, only up to the connector of the evacuation pipe 6, i.e. in front of or above the brush 3, which is rotating with a high rate of revolution.

The method and the arrangement according to the invention enable the achievement of a closed system such that dissolved dirt, in particular, and cleaning liquid are not spread around the location that is being cleaned, but are efficiently extracted by suction through the evacuation pipe to the liquid container. Thus, the mouthpiece 1 is very efficient in preventing the spread of hazardous chemicals in the surroundings or in the environment, and it reduces significantly also the health risks for the user.

Although only one brush 3 is shown in the mouthpiece 1 in the embodiment shown, it is obvious that the mouthpiece can be provided with several brushes next to each other in order to carry out the task of brushing up the dissolved dirt and the residual cleaning liquid in order to form small pararticles of liquid, particles in aerosol form, which can be removed by the evacuation pipe.

Also a support frame 10 is shown in the drawings in order to be able to handle the mouthpiece 1 according to the invention, as is also a jointed rod fixture 11, in order to be able to connect a rod (not shown in the drawings) to the mouthpiece in order to make it easier to manoeuvre it from a comfortable working stance. It is appropriate that the support frame 10 be arranged at the level of the lower part of the mouthpiece 1 in such a manner that a glide support 12 arranged at the rear edge of the support frame 10, together with the brush 3, are the only parts of the arrangement that make contact with the surface that is to be cleaned, the result of which is that the mouthpiece in itself does not contribute to spreading dirt or graffiti across the surface. The stiffness and length of the bristles of the brush 3 are adapted such that the brush can both support the mouthpiece 1 across the surface and can clean the surface, while at the same time brushing up not only cleaning liquid but also dissolved particles of dirt, such that these can form aerosols. The attachment of the jointed rod fixture 11 in the arrangement is between the brush 3 and the glide support 12 of the support frame 10, such that the mouthpiece can be efficiently pressed against the surface that is to be cleaned without any risk that the mouthpiece cover 2 will come into direct contact with the surface that is being cleaned. The diameter of the brush 3 together with the glide support 12 of the support frame 10 ensure that the mouthpiece is maintained at a small distance above the surface that is to be cleaned, and thus allows air to be drawn in under the mouthpiece while at the same time the mouthpiece is prevented from being drawn by suction against the surface that is to be cleaned.

The cleaning liquid that has been mentioned in the description may be of various types, depending on the type of dirt or graffiti that is to be removed from the surface. Thus the cleaning liquid may comprise anything from water to concentrated chemical liquids, including toxic or corrosive substances. It is appropriate that the density of the cleaning to liquid be adapted not only such that the liquid remains on the surface if it is vertical, but also such that the liquid can be brushed up by the rotating brush and, together with dissolved dirt and the flow of air, form aerosols that can be transported away through the evacuation pipe.

The liquid in the aerosol flow that passes through the evacuation pipe 6 is separated from the air with the aid of a cyclone in the liquid collection arrangement 7 and is led onwards to the container 9. It is appropriate that the container 9 be constituted by a container that previously has contained cleaning liquid of the same type and that has been applied to a surface, i.e. a used container for new cleaning liquid. The container 9 in this case may already be provided with labelling 13 that describes the contents, and this means that subsequent destruction of the cleaning liquid is made significantly easier. Since the method and the arrangement according to the invention act, in principle, as a closed system, the risks for the personnel who handle the equipment, and the risks for the environment, can be limited.

It is possible that the mouthpiece according to the invention be supplemented with a supply line and one or several spray nozzles, together with an operating arrangement for these, in order to apply a post-cleaning liquid, principally containing water, after the graffiti has been removed, in order to rinse away residual used cleaning liquid. It may also be arranged such that also this post-cleaning liquid is withdrawn by suction with the aid of the mouthpiece and the evacuation pipe connected to it, although it is in this case appropriate that it be led away to a separate container. It can also be envisaged in this case that this post-cleaning liquid is reused, and that it can thus be supplied through the supply line after it has been collected in the container. The supply line and the spray nozzles may also be used in order to rinse away other dirt from a surface on which graffiti is present before the said removal of graffiti.

1. A method for the cleaning of a soiled surface in which cleaning liquid is applied to the surface that is to be cleaned, characterised in that a mouthpiece (1) provided with a mouthpiece cover (2) is passed over the surface that has had the cleaning liquid applied to it, at the same time as a brush (3) mounted inside the mouthpiece cover and having a principally cylindrical form with its axis (4) principally parallel to the coated surface, and having such a diameter that it protrudes somewhat outside of the mouthpiece (1) in a direction towards the surface that is to be cleaned, is caused to rotate with a rate of revolution of approximately 2,000 rpm or higher in order to support the mouthpiece and treat the surface with the applied cleaning liquid and to break up the cleaning liquid and the dirt that has been dissolved by the cleaning liquid and the brush into small particles that are withdrawn by suction from the mouthpiece cover (2) and from the surface with the aid of an evacuation pipe (6) that is connected to the mouthpiece cover (2) by a connector (5).

2. The method according to claim 1, characterised in that the mouthpiece at the side that faces the surface that is being cleaned has a distance from the surface or has openings in the mouthpiece cover (2) such that air can be drawn in under the mouthpiece in order to be mixed with the particles, such that negative pressure created by the evacuation pipe (6) withdraws by suction the air and the particles from the mouthpiece (1) through the evacuation pipe.

3. The method according to claim 1, characterised in that the evacuation pipe (6) is connected to a liquid container (9) such that used cleaning liquid and particles of dirt are collected in the liquid container (9).

4. An arrangement for the cleaning of a soiled surface in which a cleaning liquid is applied to the surface that is to be cleaned, characterised in that the arrangement comprises a mouthpiece (1) that is equipped with a mouthpiece cover (2) designed principally such that it makes contact with the surface that is to be cleaned, whereby the mouthpiece cover (2) of the mouthpiece comprises a connector (5) for an evacuation pipe (6) and where the mouthpiece (1) furthermore is equipped with a rotating brush (3) with a cylindrical form, which brush rotates at a rate of revolution of approximately 2,000 rpm or higher and has such a diameter that it protrudes somewhat outside of the mouthpiece (1) in a direction towards the surface that is to be cleaned such that it rotates around an axis (4) that is parallel to the surface that is to be cleaned in order to support the mouthpiece and treat the surface with the applied cleaning liquid and break up the cleaning liquid and the dirt that has been dissolved by the cleaning liquid to small liquid particles, which particles can be withdrawn by suction through the evacuation pipe (6).

5. The arrangement according to claim 4, characterised in that a support frame (10) is connected to the mouthpiece and comprises a glide support (12) arranged to, together with the brush (3), maintain the mouthpiece at a certain small distance from the surface that is being cleaned.

6. The arrangement according to claim 4, characterised in that the evacuation pipe (6) is connected to a liquid container (9) that is arranged to receive dissolved dirt and used cleaning liquid.

7. The arrangement according to claim 4, characterised in that also a supply line and one or several spray nozzles are connected to the mouthpiece in order to either before or after the cleaning of the surface, or both, supply a further cleaning liquid for rinsing of the surface that is to be cleaned or that has been cleaned.

8. The arrangement according to claim 5, characterised in that also a supply line and one or several spray nozzles are connected to the mouthpiece in order to either before or after the cleaning of the surface, or both, supply a further cleaning liquid for rinsing of the surface that is to be cleaned or that has been cleaned.

9. The arrangement according to claim 6, characterised in that also a supply line and one or several spray nozzles are connected to the mouthpiece in order to either before or after the cleaning of the surface, or both, supply a further cleaning liquid for rinsing of the surface that is to be cleaned or that has been cleaned.

10. The method according to claim 2, characterised in that the evacuation pipe (6) is connected to a liquid container (9) such that used cleaning liquid and particles of dirt are collected in the liquid container (9).
